(19) United States
(12) Patent Application Publication
(10) Pub. No.: US 2005/0195830 A1
(43) Pub. Date: Sep. 8, 2005

(54) User directed background transfer and data storage

(75) Inventors: Prabhakar R. Chitrapu, Blue Bell, PA (US); Alain Charles Louis Briancon, Poolesville, MD (US); John David Kaewell JR., Jamison, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/059,205

(22) Filed: Feb. 16, 2005

Related U.S. Application Data
(60) Provisional application No. 60/545,669, filed on Feb. 18, 2004.
(60) Provisional application No. 60/546,135, filed on Feb. 20, 2004.

(51) Int. Cl. H04L 12/28

(52) U.S. Cl. 370/395.21

(57) ABSTRACT

One embodiment of the present invention, file transfers are performed in a wireless communication network between a wireless transmit/receive unit (WTRU) and a location external to the WTRU for purposes of utilizing the data under predetermined conditions. In another embodiment, file transfer is performed by determining conditions for file transfer using the WTRU. The file transfer takes place subject to the determined conditions, and using the WTRU to automatically request the file transfer in response to the existence of the determined conditions.

### CROSS REFERENCE TO RELATED APPLICATION(S)

This application claims the benefit of U.S. provisional application Nos. 60/545,669 filed on Feb. 18, 2004, and 60/546,135 filed on Feb. 20, 2004, which are incorporated by reference as if fully set forth.

### FIELD OF INVENTION

This invention relates to wireless digital communication. More particularly, the invention relates to management of data in such systems.

### BACKGROUND

Mobile wireless communications have progressed from closed platforms in primarily voice based cellular phones to becoming embedded in a variety of open platforms which support data and voice such as smartphones, notebook computers and personal digital assistants (PDAs).

Presently, cell phones have only a small amount of memory, in which the user related dynamic data can be stored. As advanced services are being implemented on cell phones and cellular networks, there is an increasing need to store more and more user related dynamic data on the cell phone. Examples of such data are applications, games, music files, image database, etc.

Also, presently, mobile wireless devices which are data capable can download ring tones, music files or applications when the user is in an active data session. However, when the user is ready to download, the network conditions may not be optimal, either in terms of resource availability or in terms of cost of download. On the other hand, when the network is optimal, the user may not find it convenient to start a download session. In this sense, the user may wish to make a selection of a file transfer function at a time when the execution of the file transfer is inopportune. The time of execution may not be optimal because of considerations of availability of services, cost of services, interference with active use of the cell phone, and battery usage.

Similarly, network maintenance communications are generally provided on user request. While it is possible to provide such communication in response to system requests, it is impractical to predict times of inactivity and convenient times for subscribers to receive such communication. Therefore, communications are often executed in response to user requests, rather than at optimum times. Routine updates are often not performed on a regular basis because the execution of frequent updates could be inconvenient.

Accordingly, it is desirable to have alternate approaches to transfer data and/or store data for wireless devices.

### SUMMARY

In one embodiment of the present invention, file transfers are performed in a wireless communication network between a wireless transmit/receive unit (WTRU) and a location external to the WTRU. This allows the user or the WTRU to transfer the data under predetermined conditions. In another embodiment, file transfer is performed by determining conditions for file transfer using the WTRU. The file transfer takes place subject to the determined conditions, and using the WTRU to automatically request the file transfer in response to the existence of the determined conditions.

### BRIEF DESCRIPTION OF THE DRAWINGS

FIG. 1 is a diagram showing a representation of a subscriber network.

FIG. 2 is a flow diagram showing method of file transfer executed in accordance with one embodiment of the invention.

FIG. 3 is a diagram showing connection of a WTRU to an external memory device provided as a network service.

FIG. 4 is a diagram of a network in which an external memory device is accessed by a WTRU.

FIG. 5 is a diagram of a WTRU in which an external memory device is accessed through a user data port.

FIG. 6 is a schematic block diagram of a semiconductor integrated circuit (IC) chip used to implement data transfer functions in accordance with the present invention.

### DETAILED DESCRIPTION OF THE PREFERRED EMBODIMENTS

A wireless transmit/receive unit (“WTRU”) includes but is not limited to a user equipment (UE), mobile station, fixed or mobile subscriber unit, pager, or any other type of device capable of operating in a wireless environment. These exemplary types of wireless environments include, but are not limited to, wireless local area networks (WLANs) and public land mobile networks. A “base station” includes but is not limited to a Node B, site controller, access point or other interfacing device in a wireless environment. In many cases, communication can be effected through a variety of network services.

In an embodiment, a WTRU allows a user to select criteria for background file transfer execution. The criteria can include preferred network services, time of day, geographic area, cost of services, available network security levels, availability of external storage, and other functions related to the operation of the WTRU. The user may then classify file transfers. When the existing conditions meet the classification, the transfer is executed.

Background file transfer execution can occur at a time and place which does not require active participation by the user. The transfer can occur with or without the user running other processes, such as voice or data communication. Background file transfer can also be executed during times when the user is not actively involved with the operation of the WTRU. By way of example, it is common for network services to have reduced utilization at certain hours, and it is common for people to have rechargeable WTRUs connected to a power supply at that time. If the WTRU is able to receive signals, files may be transferred in the background in the sense that the user is not actively participating.

The user can make requests of particular transfers at one time, and have the execution of the transfer take place at another time and place. Thus, for example, the user may select a particular music file or ring tone, but not wish to download the file at that time. This would avoid the file transfer consuming user resources or being effected at a less than optimum cost to the user. Rather than requiring that the user to execute the file request at an optimum time and place for the file transfer, the user may execute the request, at least on the WTRU, and the WTRU will effect the transfer at a time and place selected in accordance with predetermined criteria. The predetermined criteria can be used to manage transfer of files so that the transfer can occur at a time and place which is more convenient in terms of cost, functionality, use of the WTRU and use of network resources.

Transfer requests may also be initiated by the network. Network initiated transfer requests may be used, for example, to provide program updates, network-related data and other housekeeping functions.

When the transfer is taking place or is about to take place, an alert signal (visual or auditory) can be provided to notify the user that the transfer is completed. It is also possible to provide a log or a detailed session record of the session, which can be stored in the WTRU upon completion of the transfer. The log will have details that can be generated by the WTRU itself (such as number of attempts etc) and also details that have to be furnished by the network (cost and amount of data etc). Alternatively, the session record details may be appended to the downloaded data itself or be sent as a message (e.g. SMS) by the network to the WTRU and stored separately in a download log.

In a further embodiment, the WTRU tracks usage events and uses this information to create default parameters, such as time of transfer. If a predetermined set of user activity events are absent during a particular time of day, the WTRU can retain this information in a database so as to indicate times of inactivity. This information can be combined with detected times of low network usage or user input of preferred times and events, such as battery recharge periods, which can be used as criteria for indicating when the transfer of files should be executed. The user may then select to have the transfer of files occur on an automatic basis in accordance with the default parameters or parameters which have been modified by the user. Further factors include identified costs assigned to different services used for file transfer and user selection of services to be used for file transfer.

When the user requests a file transfer, a selection is made as to whether the file should be transferred as soon as possible or in accordance with the criteria for background transfer. If background transfer is desired, the request for file transfer is stored in memory, and a request for execution is made in accordance with the predetermined criteria.

Selection of time and mode of background transfers can be manual or automatic. As an example of automatic selection of time and mode, the WTRU can maintain a database of user activities. The database would indicate time of no activity, so that, if a user seldom engages the WTRU in certain hours, the WTRU can set those times for background transfers. Those times would be combined with availability of services meeting predetermined parameters, and other conditions, such as battery charge status. For example, a configuration in which a battery is being recharged can be used to indicate a quiescent use time during which file transfers would not require battery power. Examples of criteria would include particular wireless networks, time of day, geographic area, cost of services, and available network or application security levels.

The ability to perform unattended data transfers permits execution of the transfer in a manner which can be performed at low cost, but which would be impractical if executed manually. This can be achieved by executing the transfer on network services which are underutilized at the time of transfer. By way of example, a cellular voice channel may have less than optimal data rates, but may be underutilized in early morning hours. While data transfer rates would be especially slow, it is possible, for example, to use data transfer protocols which are compatible with the voice channel to reliably perform the data transfer, given enough time. It is presumed that the user would not be actively using the voice channel at the times selected, and the network facilities would be underutilized at the time of the transfer. It may also be the case that the WTRU is connected to an external power source at that time, so that power usage would not be a factor.

1 It is also possible to transfer data packets during the silence periods in a voice conversation. In instances where the user has established a duplex communication link between himself and the network for voice communication, the actual voice communication is often simplex, so that the downlink is typically quiet when the uplink voice link is busy. During these times, network can download data to the WTRU without a requirement to provide extra radio resources. This can result in cost savings to the network or to the user. This use of silence periods for data transfer is particularly advantageous in cases in which a secondary data channel is unavailable, or in cases in which a combined voice and data channel is used.

Additionally, network report information may be used as file transfer criteria. To illustrate, the WTRU queries the network to report the loading level. Alternatively, the WTRU sends a probe data packet and estimates the load by measuring the response time, or the WTRU senses network activity. Likewise, cost of services can be determined through a process of network interrogation.

Regular functions can also be assigned background transfer. For example programming updates for the WTRU can be performed at regular intervals, but only when the predetermined criteria are met. This allows changes to be made on a regular basis to the WTRU's program and database relevant to network changes without adversely affecting the network or the WTRU.

The invention permits a background data session to be initiated by the WTRU in a way that is transparent to the user, in that the WTRU performs the requested download and terminates the session. If the complete download is not successful, additional attempts are made either until completely successful or until a maximum number of retrials is reached as set by the user.

FIG. 1 is a diagram showing a representation of a subscriber network 11. The network 11 includes a radio network controller 12 and one or more base stations 21-24. The base stations communicate with one or more WTRUs 31. Some of the base stations 21, 22 may be connected to an auxiliary network 36, which may be a different type of service or a competitor's network, to which the WTRU 31 may connect in a “roaming” mode. The network 11 also includes connections to other network services, such as “hot spots” 41, 42.

If the user of the WTRU 31 decides to execute a file transfer, for example from a remote location or from the network, as represented by data store 47, the user issues the file transfer request. According to the invention, the file transfer request may be deferred according to the factors described infra. In the example depicted, the user decided to request the file transfer while communicating through auxiliary network 36 (base station 21). The transfer may be more optimal if actually executed through a “hot spot” 41, 42, through the user's home network (base stations 23, 24, or at a more convenient time). The request for transfer is stored by the WTRU in memory 49 and executed when the desired conditions are met.

In the case of “hot spots”, a file transfer may be more expeditious at a “hot spot” 41, 42 but may or may not be more costly. In accordance with the present invention, a determination is made whether to select the “hot spot” 41, 42 for deferred transfer in accordance with the conditions selected for deferred transfer. Thus, while immediate transfer may be optimum at the hot spot, the invention is capable of redirecting the transfer in accordance with what would be optimum given the possibility of meeting predetermined conditions prior to file transfer.

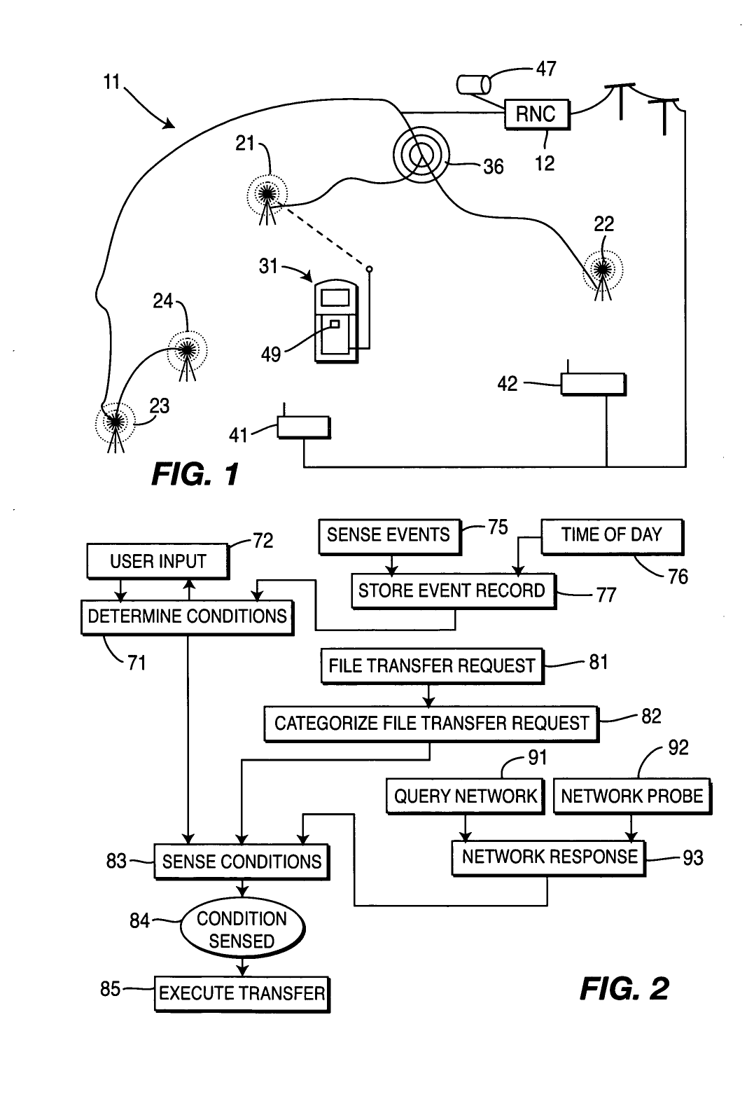

FIG. 2 is a flow diagram showing the inventive method. A determination of conditions (step 71) is performed according to system defaults, user input (step 72) and historical data determined by sensing events coordinated with time of day (steps 75, 76), to provide a stored event record (step 77).

Upon receiving a file transfer request (step 81), the file transfer request is categorized (step 82) as to whether the transfer will be deferred according to the sensed conditions (step 83). When the condition is sensed (step 84), the requested file (step 81) is executed (step 85). The sensing may include data already stored by the WTRU or may include the results of a query of the network (step 91) or a network probe to determine network conditions (step 92). The query or probe generates a network response (step 93) which becomes one of the sensed conditions (step 83).

In another embodiment, a WTRU accesses storage memory external to the WTRU for storing data. The data stored in the external memory may include user data, personalized data and program data. In one particular embodiment of the invention, the external memory access is achieved through a local memory port intended to communicate with an external data storage device. The external memory access may be achieved through an external physical device such as a memory drive or a computer, or a storage device associated with the WTRU. In an alternate embodiment, the external memory access is achieved through a wireless communication link. The wireless communication link can provide memory access to either external user equipment or a network supplied data storage facility.

In the sense of this invention, “external” means connected through a data port or other communication link. In some cases the physical location of the external storage will be in the WTRU's chassis. Such internal mounting of external storage is considered to be within the scope of the present invention.

Data used by a WTRU is made accessible by providing an external data conduit connecting external memory to the WTRU. The external memory device is added to a WTRU and managed as virtual memory structure when appropriate. Typical implementations of a local external memory would include a memory stick connected to the cell phone via a port configured to accept memory stick devices, or a memory device connected via a data port such as a USB port. For network memory, the location for the user associated memory can be anywhere accessible to the network may be provided either by the network or by the user (home personal computer) or third party.

The use of external memory facilitates easy replacement of a WTRU. A WTRU includes various functions, many of which are programmed. The program functions include a personalized part, and an impersonal part. The personalized part may include functions such as an address book, voice tags, voice recognized phone commands, ring tones, screen savers, voice mail greetings, etc. The impersonal part may include functions such as communication protocols, hardware functions, software functions related to the network, etc. When a user wants to replace a cell phone with a new one, he/she would like to carry over the personalized part as easily as possible. While it would be convenient to include the impersonal part, such as a “PRL”, the transfer of the impersonal part is generally accommodated by an initialization procedure. Using the external memory permits the user to transfer all of a predetermined set of personalized data outside the WTRU for later retrieval. The later retrieval can be to the same WTRU, a different WTRU or a diverse device. The transfer of personalization data from one WTRU to another permit transfer of the personal preferences and other data between WTRUs without a need for extensive manual programming.

According to one embodiment of the invention, a tagged cataloging of applications is implemented. The tagged cataloging may be accomplished by simple tag or meta tag, and allows applications to be moved either by the user or automatically by a server from one component of the memory to another.

The invention allows reduced cost of upgrade to customer, encourages operator's customers to stay with operator (reduces churn), and facilitates exchange of models of WTRUs.

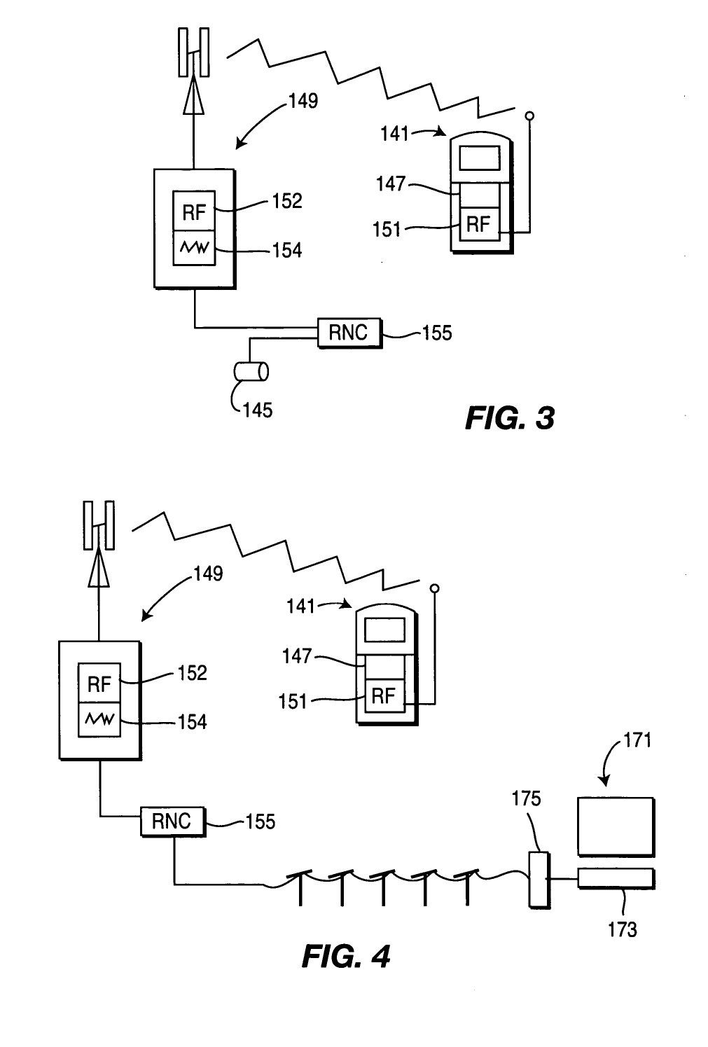

FIG. 3 is a diagram showing connection of a WTRU 141 to a network data store 145 provided as a network service. The WTRU 141 includes processing circuitry with data storage 147 as a part of the WTRU 141. Communication with a radio network through base station 149 is established by RF circuitry 151 on the WTRU 141. The base station includes RF circuitry 152 for establishing a communication link with the WTRU 141 and processing circuitry 154 for maintaining the communication link and communicating with a radio network controller (RNC) 155. The RNC 155 provides a connection to network data store 145. Data on the network data store 145 includes data dedicated to the WTRU 141 or indexed for availability to the WTRU 141.

FIG. 4 is a diagram of a network in which an external memory device is accessed by a WTRU 141. As is the case described in connection with FIG. 3, the WTRU 141 includes processing circuitry with data storage 147 as a part of the WTRU 141. Communication with a radio network through base station 149 is established by RF circuitry 151 on the WTRU 141. The base station includes RF circuitry 152 for establishing a communication link with the WTRU 141 and processing circuitry 154 for maintaining the communication link and communicating with a radio network controller (RNC) 155. The RNC 155 provides a further network connection which connects to an external device 171. In the example shown, the external device 171 includes a computer 173 with a data storage device (hard drive, not separately shown) and uses a modem connection 175 to connect to the computer 173. The computer 173 serves as a data store, so that the computer's hard drive provides the external data store for the WTRU 141. As described in connection with FIGS. 2 and 3, file transfers are performed according to system defaults, user input, historical data and predetermined events such as time of day. A file transfer request is categorized to determine if will be deferred according to the sensed conditions, and when the condition is sensed, the request is executed.

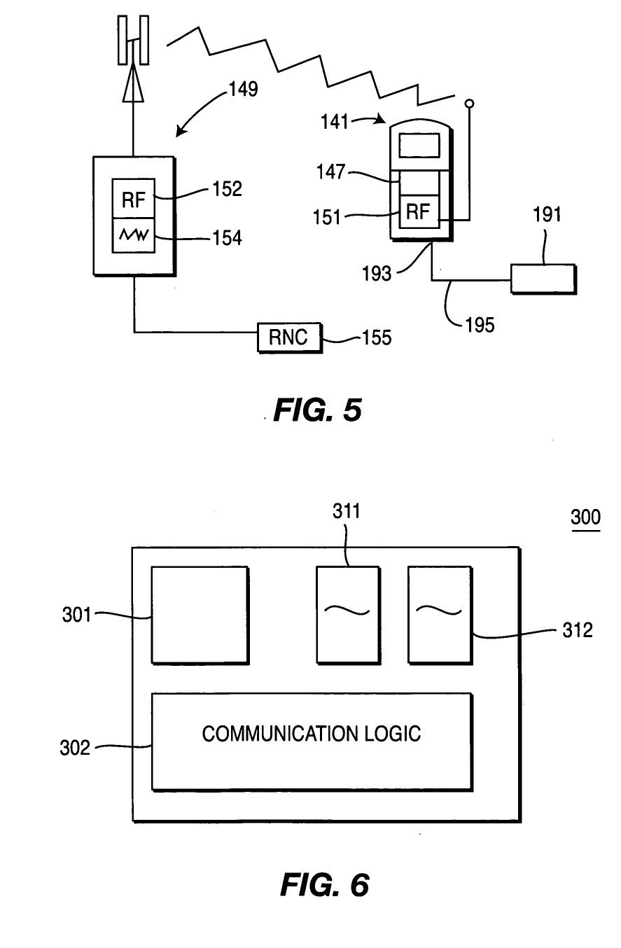

FIG. 5 is a diagram of a WTRU in which an external memory device 191 is accessed through a user data port 193. As in the configurations above, the WTRU 141 includes processing circuitry with data storage 147 as a part of the WTRU 141. Communication with a radio network through base station 149 is established by RF circuitry 151 on the WTRU 141. The communication with the radio network connects the WTRU to the network in the usual manner, but is not required to provide access to the external memory device 191. In this example, the external device 191 is physically external to the WTRU 141 and uses a cable connection 195 to connect the WTRU 141 to the data store 191. It is also possible to use a local wireless connection for the purpose. While the memory device 191 is shown external to the physical case of the WTRU 141, it is possible to retain the external memory device 191 within the WTRU 141 either for the duration of the transfer of data between the WTRU 141 and the memory device 191 or on a semi permanent basis.

FIG. 6 is a schematic block diagram of a semiconductor integrated circuit (IC) chip 300 used to implement data transfer functions in a WTRU. One such implementation would include a programmable logic unit 301 controlling a communication logic module 302. The communication logic module 301 controls signal logic modules 311, 312. Data transfer functions are executed data transfer between the WTRU and an external device or memory store is performed through the signal logic modules 311, 312 in accordance with the availability of data links. The transfer of data provides the communication links described in connection with FIG. 2. While a programmable logic unit 301 is shown, it is understood that the logic function can be executed through external programming, either through a separate IC chip or other technique for implementing programmed commands.

1. In a wireless communication network which includes at least one base station and a plurality of wireless transmit/receive units (WTRUs), a method of effecting data transfer comprising:
selecting a WTRU;
determining conditions for data transfer using the WTRU;
selecting the data transfer to take place subject to the determined conditions; and
using the WTRU to automatically request the data transfer in response to the existence of the determined conditions.

2. The method of claim 1, wherein the determining of conditions for data transfer includes an availability of external storage of data for the WTRU.

3. The method of claim 1, wherein:
the determining of conditions for data transfer includes user selection of criteria for background data transfer execution; and
the user classifies data transfers, and if the classification applies, selecting transfer according to the selected criteria and executing the transfer in response to meeting the criteria.

4. The method of claim 1, wherein the determining of conditions for data transfer includes user selection of criteria for background data transfer execution, the criteria including one of preferred network services, time of day, geographic area, cost of services, availability of power resources, and available network security levels.

5. The method of claim 1 further comprising the providing transfer requests initiated by the network in order to provide background updates of network-related data.

6. The method of claim 1, wherein the user can make requests of particular transfers at one time, and have the execution of the transfer take place at another time and place selected in accordance with predetermined criteria.

7. The method of claim 1, wherein the determining of the conditions for data transfer includes the WTRU tracking usage events and using this information to create default parameters.

8. The method of claim 1, wherein:
the determining of the conditions for data transfer includes the WTRU tracking usage events and using this information to create default parameters, and the user may then select to have the transfer of files occur on an automatic basis in accordance with the default parameters or parameters modified by the user; and
the selection of the data transfer to take place subject to the determined conditions includes a selection of whether to apply the determined conditions to the transfer, thereby permitting selection of whether the file should be transferred as soon as possible or in accordance with criteria for background transfer.

9. The method of claim 1, comprising, in the case of the data transfer not succeeding, making additional attempts until completely successful up to a predetermined maximum number of retrials is reached.

10. The method of claim 1, comprising:
classifying the data transfer in accordance of whether to apply at least a subset of said determined conditions; and
applying the selection of the data transfer according to the classification, thereby applying the determined conditions to the transfer according to the classification.

11. The method of claim 1 comprising:
interrogating the network in order to determine the existence of at least one condition;
at least one of said conditions including network activity as determined by the WTRU; and
at least one of said conditions including network activity as determined by the WTRU in response to interrogating the network.

12. The method of claim 1 comprising determining determine the existence of at least one condition, said condition including cost of network services determined through interrogation of the network.

13. The method of claim 1 comprising scheduling regularly scheduled data transfers, the transfers executed upon occurrence of said determined conditions.

14. A wireless transmit/receive unit (WTRU) for performing the method of claim 1.

15. A wireless transmit/receive unit (WTRU) capable of transferring data comprising:
a program function capable of storing and retrieving data in a memory of the WTRU and implementing program functions using said data stored in the memory of the WTRU;
a program function capable of storing and retrieving data in a further memory external to the WTRU; and
a connection capable of transferring data between the WTRU and the further memory, wherein the data transferred between the WTRU and the further memory represents data stored in the memory of the WTRU, permitting the WTRU to implement the program functions using the data stored in the memory of the WTRU by transferring the data between the further memory external to the WTRU and the memory of the WTRU.

16. The WTRU of claim 15 wherein:
the transfer of data includes personalized information specific to the user's operation of the WTRU; and
transfer of the data from a first WTRU to the further memory followed by transfer of the data from the further memory to a second WTRU results in a transfer of programming selections related to user operation of the WTRU from the first WTRU to the second WTRU.

17. The WTRU of claim 15 further comprising:
the external memory location provided through a communication link, access to a memory location selected by the user as the further memory external to the WTRU; and
the memory location selected by the user accessed by the WTRU through a network associated with the WTRU.

18. The WTRU of claim 15 further comprising the further memory external to the WTRU as a memory device connected through a data port on the WTRU.

19. The WTRU of claim 15 further comprising the providing transfer requests initiated by the network in order to provide background updates of network-related data.

20. In a wireless subscriber network, a method for data management for data stored by wireless transmit/receive units (WTRUs) capable of processing and transferring data, the method comprising:
providing a operational data store for data associated with the WTRU, in communication with a processor in the used for said processing of data;
providing a data store for further data associated with the WTRU, external to said data store in communication with the processor, wherein the data store in communication with the processor includes at least a portion of the data in the data store for further data;
providing a communication link including a data connection between the WTRU and the data store for further data;
performing a program function which includes manipulating data in the operational data store for data associated with the WTRU; and
storing and retrieving data in the data store for further data to replicate data in the operational data store for data associated with the WTRU and to retrieve said replicated data,
wherein the data connection provides a capability of transferring data between the WTRU and the data store for further data, wherein the data transferred between the WTRU and the data store for further data represents data stored in the operational data store for data associated with the WTRU, permitting the WTRU to implement the program functions using the data stored in the operational data store for data associated with the WTRU by transferring the data between the data store for further data external to the WTRU and the operational data store for data associated with the WTRU.

21. The method of claim 20 comprising:
determining conditions for data transfer;
using the WTRU to select a data transfer;
selecting the data transfer to take place subject to the determined conditions; and
using the WTRU to automatically request the data transfer in response to the existence of the determined conditions.

22. The method of claim 20 wherein:
the transfer of data includes personalized information specific to the user's operation of the WTRU; and
transfer of the data from a first WTRU to the data store for further data followed by transfer of the data from the data store for further data to a second WTRU results in a transfer of programming selections related to user operation of the WTRU from the first WTRU to the second WTRU.

23. The method of claim 20 further comprising:
providing through the communication link access to a memory location selected by the user as the data store for further data external to the WTRU; and
the memory location selected by the user accessed by the WTRU through the wireless subscriber network.

24. A semiconductor integrated circuit (IC) chip for controlling communication in a wireless communication network, the IC comprising:
a circuit for determining conditions for data transfer;
a circuit for controlling a connection to a communication link;
a circuit to select a data transfer subject to the determined conditions; and
a circuit for executing, through the communication link, a request the data transfer in response to the existence of the determined conditions.

25. The IC of claim 24, wherein the determining of conditions for data transfer provides external storage of data for a wireless transmit/receive unit (WTRU).

26. The IC of claim 24, wherein:
the determining of conditions for data transfer includes a user selection of criteria for background data transfer execution; and
the circuit for executing the request for the data transfer responsive to a user classification of data transfers, and if the classification applies, the circuit for executing the request for the data transfer selecting transfer according to the selected criteria and executing the transfer in response to meeting the criteria.

27. The IC of claim 24 wherein:
the transfer of data includes personalized information specific to the user's operation of a wireless transmit/receive unit (WTRU) associated with the IC; and
transfer of the data from a first WTRU to the further memory followed by transfer of the data from the further memory to a second WTRU results in a transfer of programming selections related to user operation of the WTRU from the first WTRU to the second WTRU.

28. The IC of claim 24 further comprising the further memory external to a device associated with the IC provided as a network memory location.

29. The IC of claim 24 further comprising:
the external memory location provided through a communication link, access to a memory location selected by the user as the further memory external to a wireless transmit/receive unit (WTRU) associated with the IC; and
the memory location selected by the user accessed by the WTRU through a network associated with the WTRU.
